(19) United States
(12) Patent Application Publication
(10) Pub. No.: US 2012/0158759 A1
(43) Pub. Date: Jun. 21, 2012

(54) INFORMATION PROCESSING DEVICE FOR SELECTING REAL ESTATE PROFESSIONALS

(76) Inventors: Michael M. Saigh, St. Louis, MO (US); Shelly J. Fetterhoff, Oakdale, CT (US)

(21) Appl. No.: 13/187,959

(22) Filed: Jul. 21, 2011

Related U.S. Application Data
(60) Provisional application No. 61/366,216, filed on Jul. 21, 2010.

(51) Int. Cl. G06F 17/30

(52) U.S. Cl. 707/758; 707/E17.009

(57) ABSTRACT

An information processing device includes a data base operable to receive first attribute data indicative of a plurality of real estate professionals and second attribute data indicative of a plurality of real estate properties. The information processing device includes a data processor in communication with the data base. The data processor includes application software having an algorithm operable for comparing the first and second attribute data and identifying matches therebetween.

### CROSS-REFERENCE TO RELATED APPLICATION

This application claims the benefit of U.S. provisional application No. 61/366,216, filed Jul. 21, 2010, the contents of which are incorporated herein by reference in its entirety.

### FIELD OF THE INVENTION

The present invention is generally directed to an information processing device for selecting real estate professionals, and more particularly to an information processing device having an algorithm that matches the real estate professionals' expertise with attributes of a real estate property.

### BACKGROUND

Real estate transactions typically involve one or more real estate professionals such as real estate brokers or a real estate agents interacting with a buyer and/or seller. Typically real estate professionals use a multiple listing service (MLS) to identify and advertise properties for sale. The MSL can usually be searched based on price of the real estate property. However, because of the vast number of real estate properties listed in the MSL it is difficult for some real estate professionals to have detailed knowledge about all of the listed properties.

### SUMMARY

According to aspects disclosed herein, there is provided an information processing device including a data base operable to receive first attribute data indicative of a plurality of real estate professionals and second attribute data indicative of a plurality of real estate properties. The information processing device includes a data processor in communication with the data base. The data processor includes application software having an algorithm operable for comparing the first and second attribute data and identifying matches therebetween.

The data base can include categories of real estate properties and menus for input of at least one of the first and second attribute data.

In one embodiment, the data processor is operable to identify one or more real estate professionals that have first attribute data which have one or more fields that match one or more fields of the second attribute data.

The data processor can communicate with at least one mobile communications terminal and the first and/or second attribute data can be transmitted to the data base via the mobile communications terminal.

In one embodiment, the identification of the real estate professional can be transmitted to a user via a mobile communication terminal.

### BRIEF DESCRIPTION OF THE DRAWINGS

FIG. 1 is a block diagram of the information processing device of the present invention;

FIG. 2 is a schematic illustration of a submenu for inputting a buyer's real estate property attribute data preferences into a data base;

FIG. 3 is a schematic illustration of a submenu for inputting a seller's real estate property attribute data into the data base;

FIG. 4 is an illustration of three windows displaying the status and initial results of a data comparison;

FIG. 5 is an illustration of two windows transmitting the initial results of the data comparison;

FIG. 6 is an illustration of the results of a numeric ranking of a match between a real estate professional and the real estate property;

FIG. 7 is block diagram illustrating the selection of a real estate professional and an automated response from the real estate professional; and

FIG. 7 is a flow chart illustrating the steps for selecting a real estate professional.

### DETAILED DESCRIPTION

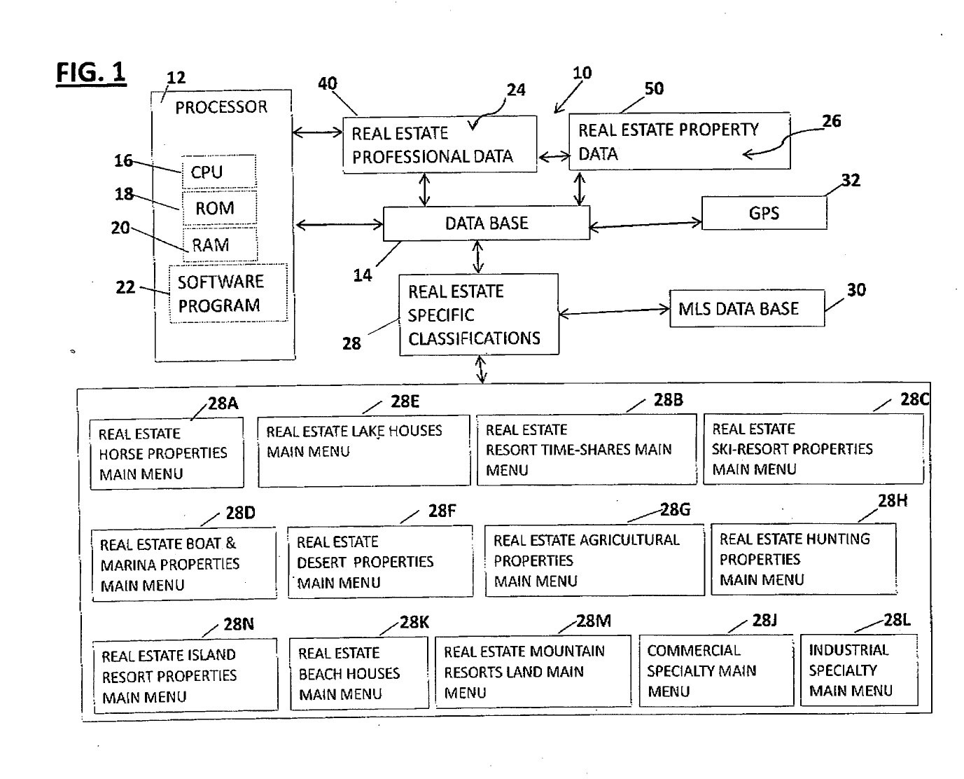

Referring to FIG. 1, disclosed herein is an information processing device 10 including a data processor 12, for example, a programmable logic controller, a computer program and/or a controller for use in matching real estate professionals (e.g., real estate brokers and agents) with a attributes of one or more real estate properties. The information processing device 10 includes a data base 14 in communication with the data processor 12. The data base 14 includes, for example, data content, files, computer memory, and computer data storage. The data processor 12 includes a computer processing unit (CPU) 16, read-only memory (ROM) 18, random access memory (RAM) 20 and application software program 22 such as an app, having an algorithm programmed therein. The data processor 12 and the data base 14 are in communication with a first communications terminal 40, for example a computer terminal or a mobile communications device such as a cellular telephone. The data processor 12 and the data base 14 are operable to receive first attribute data 24 indicative of a plurality of real estate professionals via the first communications terminal 40. The data processor 12 and the data base 14 are also in communication with a second communications terminal 50, for example a computer terminal or a mobile communications device such as a cellular telephone. The data processor 12 and the data base 14 are operable to receive second attribute data 26 indicative of a plurality of real estate properties via the second communications terminal 50. The algorithm is operable for comparing the first attribute data 24 and the second attribute data 26 and to identify portions thereof which match, to select the real estate professional most appropriate to represent the purchase or sale of the real estate property.

In one embodiment, the application software program 22 is operable as an app on a mobile telecommunication device, such as a cellular telephone. In one embodiment, the information processing device 10 and/or the application software program 22 is made available to users participating in a membership association or via a franchise agreement. In one embodiment, the data base 14 is in communication with a Global Positioning System (GPS) 32 for receiving GPS location information relating to the real estate property, the real estate professional and/or users of the information processing device 10. In one embodiment, the data processor 12 operates at speeds sufficient to communicate with and provide information to mobile telecommunication devices. In one embodiment, the data processor 12 and/or the data base 14 tracks, monitors and provides a communications link to real estate professionals, real estate purchasers and sellers. The first and second attribute data 24 and 26, respectively, can be updated on a periodic basis.

The information processing device 10 includes a real estate classification algorithm 28 in communication with the data base 14, for categorizing real estate properties based on potential uses of the properties, according to predetermined criteria based on real estate professionals' experience. In one embodiment, the classification algorithm 28 communicates with another database such as a real estate multiple listing services (MLS) data base 30 and analyzes specifications of the real estate properties described therein. As a result of the analysis, the classification algorithm categorizes the real estate properties into one or more classifications and creates menus for browsing information relating to each category.

In one embodiment, the real estate classification algorithm 28 is operable to categorize real estate properties based on attributes of the property, such as but not limited to properties suitable for horses 28A, resort and time-share properties 28B, ski resort properties 28C, properties for boating such as marinas 28D, properties having a lake or pond thereon 28E, properties in desert type areas 28F, properties suitable for agricultural activities 28G, properties suitable for hunting 28H, properties suitable for commercial businesses 28J, properties located at or near a beach 28K, properties suitable for industrial businesses 28L, properties located at or near mountains 28M and/or properties located on an island 28N.

In one embodiment, the real estate classification algorithm 28 receives information regarding the location of the property (e.g., census data, demographics, market opportunities and use of other properties in the area). The real estate classification algorithm 28 determines a value (e.g., appraisal value, income potential or resale value) of one or more of the real estate properties and identifies a use or category of the property that would yield the highest value, based upon the information received.

The first attribute data 24 which is indicative of a plurality of real estate professionals includes, for example profile information such as education, interests, hobbies, experience, certifications, awards, recognitions, location and qualifications of each of the plurality of the real estate professional. Each real estate professional inputs the first attribute data 24 into the data base 14 for each of the real estate categories 28A-N via the first communications terminal 40. In one embodiment, the first attribute data includes logos, icons or other indicia indicative of the real estate professional's expertise, for example, a horse icon indicative of the real estate professional's equine endeavors, a farm icon indicative of the real estate professional's agricultural expertise and an icon of a skier indicative of the real estate professional's experience in properties associated with ski resorts.

In one embodiment, the first attribute data 24 is obtained from the real estate professional via an examination, quiz or template associated with one or more of the real estate categories 28A-N. The examination, quiz or template is generated by the data processor 12 for presentation on a window of a display (not shown) of the first communications terminal 40. The results of the examinations and quizzes and data input on the templates is quantified by a grading scale and the real estate professionals are assigned a relative ranking such as a numerical value (e.g., on a zero to 100% scale), a number of stars (e.g., zero to five stars) and or a textual grading (e.g., (excellent, very good, good, etc.), for each real estate category 28A-N selected by the real estate professional. The relative ranking is stored in the data base 14.

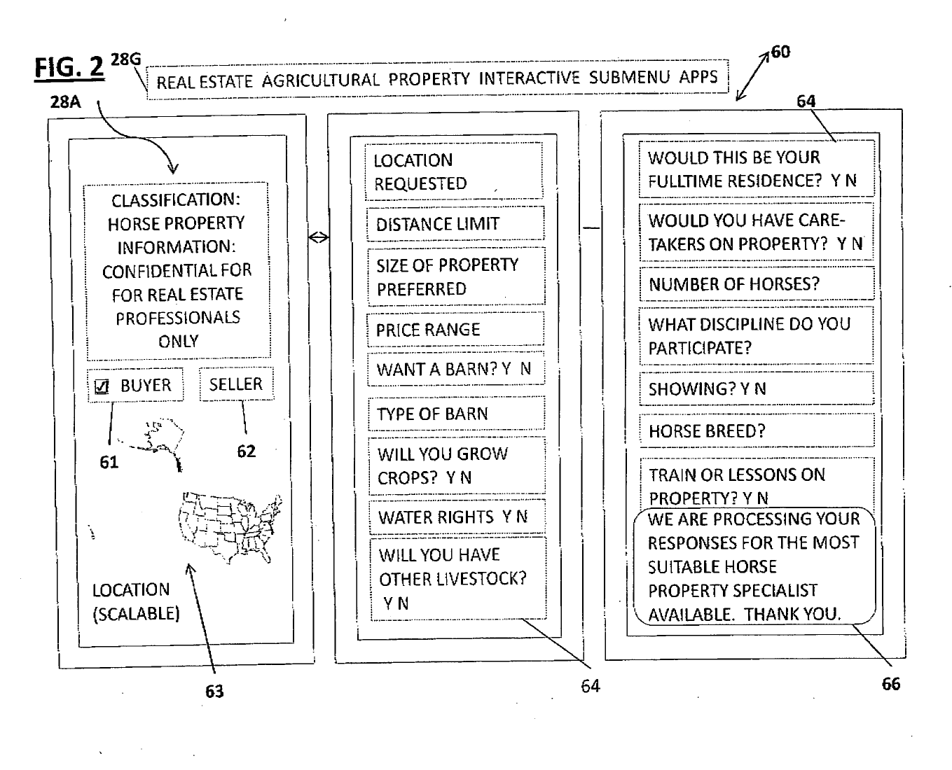

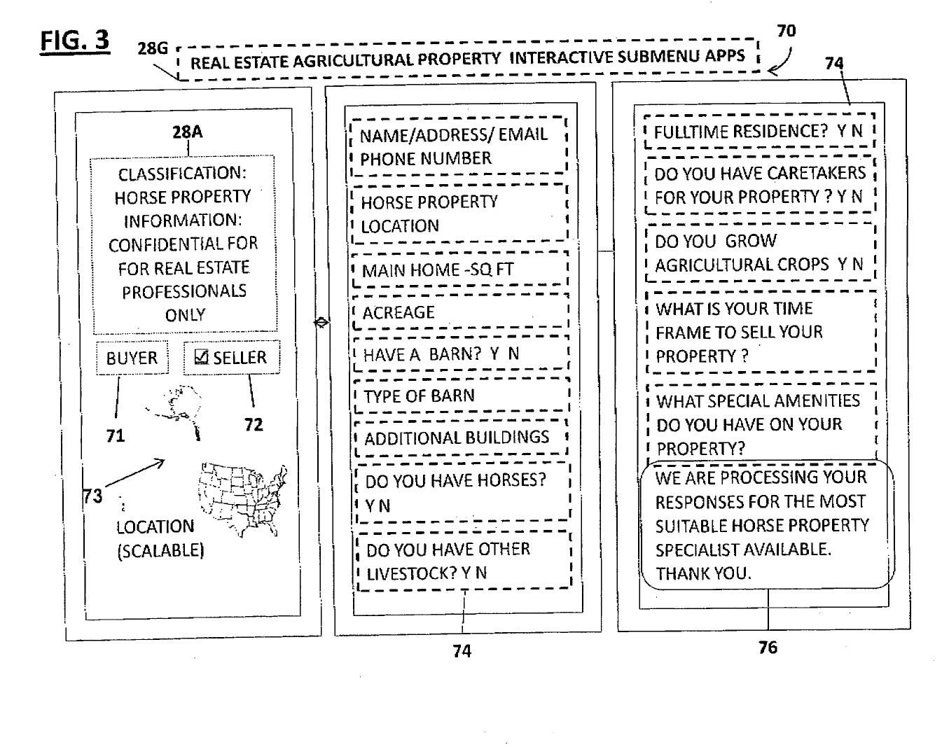

Referring to FIGS. 2 and 3, the second attribute data 26 which is indicative of a plurality of real estate properties includes buyer preferences for attributes of the real estate property sought by the buyer (FIG. 2) and attributes of the real estate property owned by one or more sellers (FIG. 3). The data processor 12 causes a submenu 60 to be presented on a window of a display (not shown) of the second communications terminal 50, as a template for entry of the second attribute data 26. As illustrated in FIG. 2, the submenu 60 for the real estate category “properties suitable for horses” 28A includes a buyer's button 61 and a seller's button 62 for activation by a user to designate the user as a buyer or seller. In addition, the submenu 60 includes an input area 63, for example a map, for identifying the location of the real estate property sought by the buyer. The submenu 60 for the real estate category “properties suitable for horses” 28A also includes a plurality of questions relating to the buyer's preferences for attributes of the real estate property, for example, distance limitations, size of property, price range, whether a barn is desired, whether crops will be grown on the property, whether water rights are desired, whether livestock would reside on the property, whether the property would be the buyer's fulltime residence, whether caretakers would be present on the property, number of horses desired to be kept on the property, discipline (e.g., amateur, novice, professional), whether the buyer plans on showing the horses, the breed of the horses and whether training or lessons would be held on the property. The submenu 60 also includes a status window 66 for displaying the status of the buyer's responses to the questions on the submenu 60. The status window 66 displays a message to the buyer, for example, “we are processing your responses for the most suitable horse property specialist available, thank you.”

Still referring to FIG. 2, the main menu of one or more related real estate property categories, such as but not limited to “properties suitable for agricultural activities” 28G is shown with the submenu 60. While the submenu 60 and questions relating to the buyer's preferences for attributes of the real estate property for the real estate category “properties suitable for horses” 28A, are shown and described, the present invention is not limited in this regard as submenus and questions relating to all of the real estate categories 28A-N and other categories can also be provided without departing from the broader aspect of the present invention.

Referring to FIG. 3, the data processor causes a submenu 70 to be presented on a window of the display of the second communications terminal 50 as a template for entry of the second attribute data 26. As illustrated in FIG. 2, the submenu 70 for the real estate category “properties suitable for horses” 28A includes a buyer's button 71 and a seller's button 72 for activation by the user to designate the user as a buyer or seller. In addition, the submenu 70 includes an input area 73, for example a map, for identifying the location of the real estate property sought by the buyer. The submenu 70 for the real estate category “properties suitable for horses” 28A also includes a plurality of questions relating to the seller's real estate property, for example, seller's contact information (e.g., name, address, e-mail address and telephone number), location of the real estate property, size of the main house, number of acres of land, type of barn, description of additional buildings, whether the seller owns horses or other livestock, whether the real estate property is the fulltime residence of the seller, whether the seller has caretakers for the property, whether the seller grows agricultural crops on the property, when the seller would like to sell the property and disclosure of any amenities present on the property (e.g., indoor arena, viewing stands, public rest rooms, etc.). The submenu 70 also includes a status window 76 for displaying the status of the seller's responses to the questions on the submenu 70. The status window displays a message to the seller, for example, “we are processing your responses for the most suitable horse property specialist available, thank you.”

Still referring to FIG. 3, the main menu of one or more related real estate property categories, such as but not limited to “properties suitable for agricultural activities” 28G is shown with the submenu 70. While the submenu 70 and questions relating to the seller's real estate property for the real estate category “properties suitable for horses” 28A, are shown and described, the present invention is not limited in this regard as submenus and questions relating to all of the real estate categories 28A-N and other categories can also be provided without departing from the broader aspect of the present invention.

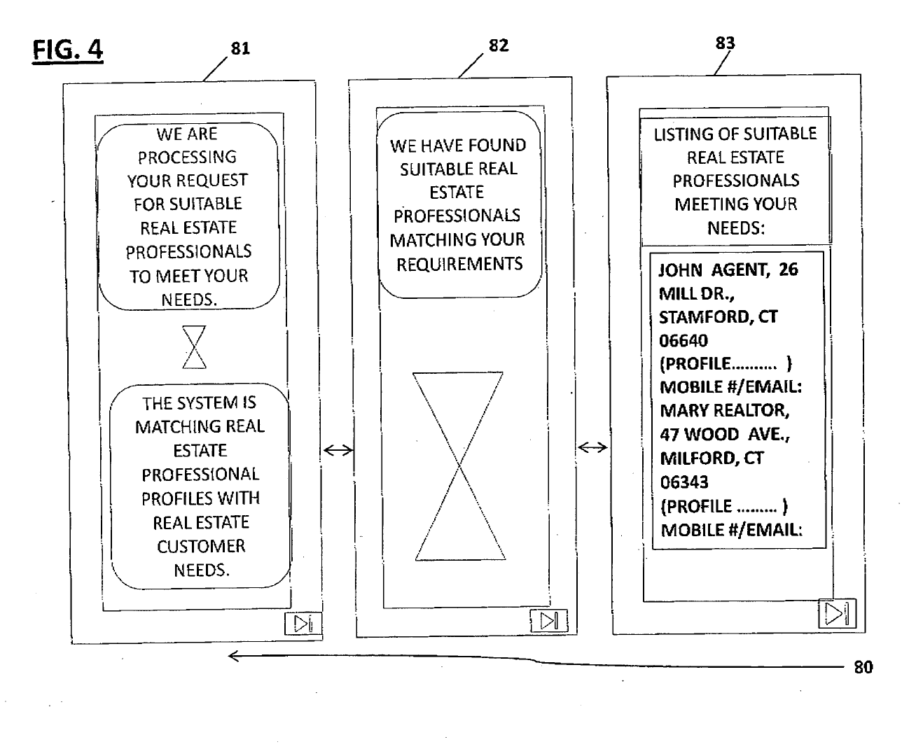

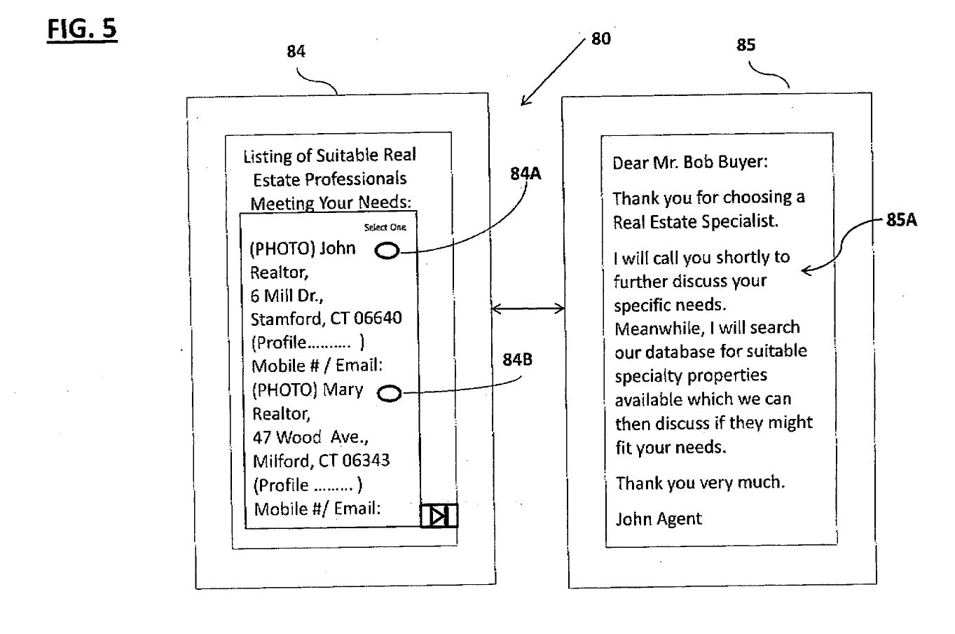

Referring to FIGS. 4 and 5, the data processor 12 causes one or more windows 80 indicating the status of a comparison of the first attribute data 24 and the second attribute data 26 to be presented on the display of the first communications terminal 40 and/or the display of the second communications terminal 50. For example, one window 81 indicates that the data processor 12 is in the process of comparing the first and second attribute data, 24 and 26 respectively, for example by stating “we are processing your request for suitable real estate professionals to meet your needs” and “the system is matching real estate professional profiles with the real estate customer needs.” Another window 82 states that “we have found suitable real estate professionals matching your requirements.” Other windows 83 and 84 display information relating to the real estate professionals had portions of the first attribute data 24 match portions of the second attribute data 26. Window 85 includes buttons 84A and 84B for selecting a suitable real estate professional. Window 85 illustrates an automated response message 85A that is sent to the real estate buyer and/or the real estate seller from each real estate professional selected.

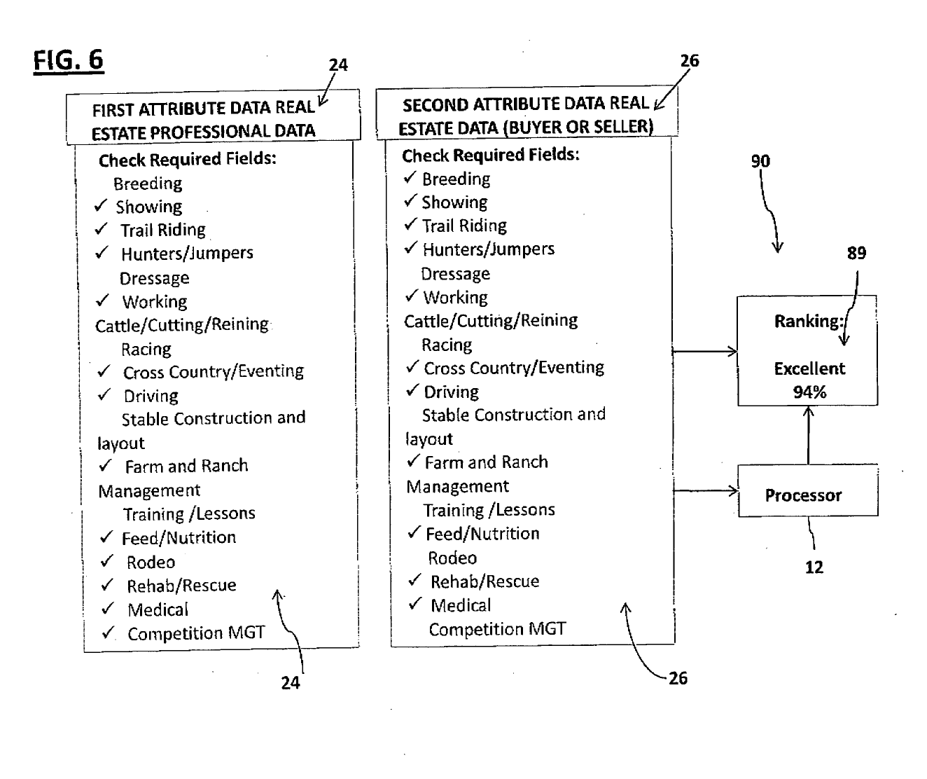

Referring to FIG. 6, in one embodiment relating to the real estate category “properties suitable for horses” 28A, the first attribute data 24 and second attribute data include seventeen fields, for example, breeding, showing, trail riding, hunter/jumpers, dressage, working cattle/cutting/reining, racing, cross country events, driving, stable construction and layout, farm and ranch management, training/lessons, feed/nutrition, rodeo, rehab/rescue, medical and competition management. Checkmarks adjacent to eleven of the second attribute data 26 fields of FIG. 6 indicate that the buyer or the seller considered eleven of the seventeen fields were important to them for the selection of a real estate professional (i.e., breeding, showing, trail riding, hunter/jumpers, working cattle/cutting/reining, cross country events, driving, farm and ranch management, feed/nutrition, rehab/rescue and medical, herein after “buyer preferences”). Checkmarks adjacent to the first attribute data 24 fields of FIG. 6 indicate where the data processor 12 identified ten matches (i.e., showing, trail riding, hunter/jumpers, working cattle/cutting/reining, cross country events, driving, farm and ranch management, feed/nutrition, rehab/rescue and medical, hereinafter real estate professional profile) between the first attribute data of the real estate professional and the eleven attribute data 26 fields of the buyer or seller. The data processor 12 calculates a numerical ranking 89 the matched attribute data fields by dividing the number fields on the real estate professionals profile (i.e., ten fields) by the number of fields in the buyer's preferences (i.e., 11 fields) and multiplying the result by 100, to arrive at a ranking of 91% (i.e., (10/11)*100). The data processor 12 causes the ranking 89 to be shown in a window 90 of the display of the first communications terminal 40 and/or the second communications terminal 50. The data processor 12 is configured to calculate the rankings 89 and cause the ranking 89 to be shown in a window 90 of the display of the first communications terminal 40 and/or the second communications terminal 50 for one or more of the real estate categories 28A-N.

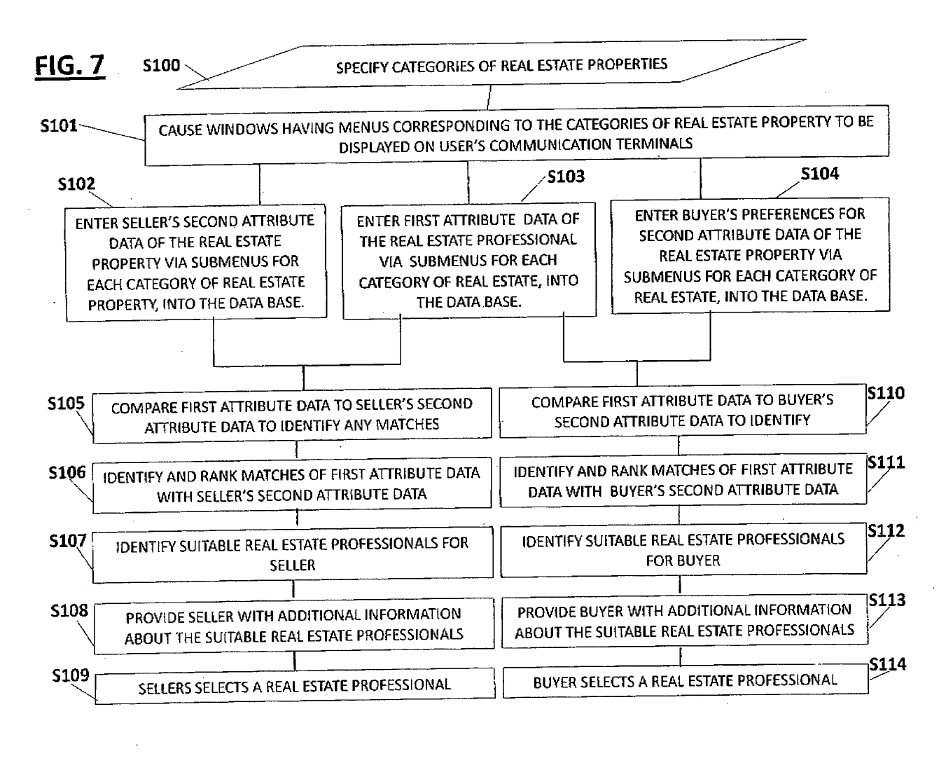

Referring to FIG. 7, steps of a method for selecting a real estate professional is illustrated. At step S100 categories (e.g., categories 28A-N) of real estate property are specified and stored in the data base 14. At step S101, the data processor 12 causes windows including menus corresponding to the categories of real estate property 28A-N to be presented in windows on the first and second communication terminals 40 and 50 respectively. The seller's second attribute data 26 is entered into the data base 14 via one or more submenus for each applicable category of real estate property S102. The first attribute data 24 of the real estate professional is entered into the data base 14 via one or more submenus for each applicable category of real estate property S103. The buyer's second attribute data 26 is entered into the data base 14 via one or more submenus for each applicable category of real estate property S104. In one embodiment, real estate professionals first attribute data 24, seller's second attribute data 26 and/or the buyer's second attribute data 26 can be communicated to the data base 14 via a mobile communication terminal, such as but not limited to a cellular telephone.

The data processor 12 compares the first attribute data 24 to the seller's second attribute data 26 and identifies any portions thereof which match S105 and S106. The data processor 12 also ranks S106 the matches between the first attribute data 24 and the seller's second attribute data 26. At step S107 the data processor identifies one or more suitable real estate professionals that would be qualified to represent the seller. In one embodiment, the identification of the suitable real estate professional can be communicated to a user (e.g., a buyer or seller) via a mobile communication terminal, such as but not limited to a cellular telephone. In one embodiment, additional information relating to the one or more suitable real estate professionals (e.g., location of the real estate professional, photograph, contact information and a list of the one or more suitable real estate professionals first attribute data 24 which match the seller's second attribute data 26 (e.g., see for example FIG. 6) is provided to the seller, step S108. At step S109, the seller selects a real estate professional. The data processor 12 continues to track and monitor correspondence between the selected real estate professional and the seller.

The data processor 12 compares the first attribute data 24 to the buyer's second attribute data 26 and identifies any portions thereof which match, steps S110 and S111. The data processor 12 also ranks S111 the matches between the first attribute data 24 and the buyer's second attribute data 26. At step S112 the data processor identifies one or more suitable real estate professionals that would be qualified to represent the buyer. In one embodiment, additional information relating to the one or more suitable real estate professionals (e.g., location of the real estate professional, photograph, contact information and a list of the one or more suitable real estate professionals first attribute data 24 which match the buyer's second attribute data 26 (e.g., see for example FIG. 6) is provided to the buyer, step S113. At step S114, the buyer selects a real estate professional. The data processor 12 continues to track and monitor correspondence between the selected real estate professional and the buyer.

In one embodiment, the method includes populating the data base 14 with attribute data of real estate consultants that have experience operating, owning, selling or buying in one or more of the categories 28A-N of the real estate properties. The data processor 12 queries the attribute data of the real estate consultants and identifies any such consultants whose attribute data is similar to that of the real estate property, the buyer preferences for the real estate property, and/or real estate professional's experience with particular types real estate such as the real estate categories 28A-N.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An information processing device comprising:
a data base operable to receive first attribute data indicative of a plurality of real estate professionals and second attribute data indicative of a plurality of real estate properties;
a data processor in communication with the data base and including application software having an algorithm operable for comparing the first and second attribute data and identifying matches therebetween.

2. The information processing device of claim 1 wherein the data base includes categories of real estate properties and menus for input of at least one of the first and second attribute data.

3. The information processing device of claim 2, wherein the data processor is operable to identify at least one real estate professional having first attribute data that has at least one field that matches at least one field of the second attribute data.

4. The information processing device of claim 1 wherein the data processor is operable to communicate with at least one mobile communications terminal.

5. The information processing device of claim 4 wherein at least one of the first and second attribute data is transmitted to the data base via the at least one mobile communications terminal.

6. The information processing device of claim 3 wherein the identification of the at least one real estate professional having first attribute data that has at least one field that matches at least one field of the second attribute data is transmitted to a user via a mobile communication terminal.
